(19) United States
(12) Patent Application Publication
(10) Pub. No.: US 2022/0094892 A1
(43) Pub. Date: Mar. 24, 2022

(54) DISPLAYING METHOD, ELECTRONIC DEVICE AND DISPLAYING SYSTEM

(71) Applicant: CASIO COMPUTER CO., LTD., Tokyo (JP)

(72) Inventor: Yoshihiko SHINOZAKI, Tokyo (JP)

(21) Appl. No.: 17/477,285

(22) Filed: Sep. 16, 2021

(30) Foreign Application Priority Data
Sep. 18, 2020 (JP) 2020-156842

(51) Int. Cl. H04N 9/31; G03B 21/20

(52) U.S. Cl. CPC H04N 9/3182; G03B 21/2053; H04N 9/3155

(57) ABSTRACT

Disclosed is a displaying method executed by an electronic device, including: obtaining image adjustment information on image adjustment for a projection device that projects an image based on image data; and displaying a preview image based on the obtained image adjustment information on a display of the electronic device without forcing the projection device to display the image.

### BACKGROUND

### CROSS-REFERENCE TO RELATED APPLICATION

This application is based upon and claims the benefit of priority under 35 USC 119 of Japanese Patent Application No. 2020-156842, filed on Sep. 18, 2020, the entire disclosure of which, including the description, claims, drawings, and abstract, is incorporated herein by reference in its entirety.

### 1. Technical Field

The present invention relates to a displaying method, an electronic device and a displaying system.

### 2. Description of Related Art

JP 2015-184299A discloses a projection device that adjusts the image quality, the light intensity and the like of a displaying image according to the usage conditions such as whether electric power is supplied from an external power supply or an internal battery and to user settings of the projector.

However, in such projection devices that adjust a displaying image according to the usage conditions and settings, the user cannot know the displaying quality of an image until the image is actually displayed.

### SUMMARY

A displaying method executed by an electronic device according to one embodiment of the present invention includes:

obtaining image adjustment information on image adjustment for a projection device that projects an image based on image data; and

displaying a preview image based on the obtained image adjustment information on a display of the electronic device without forcing the projection device to display the image.

An electronic device according to another embodiment of the present invention includes:

at least one processor that executes a program stored in a storage,

wherein the at least one processor:
obtains image adjustment information on image adjustment for a projection device that displays an image based on image data; and
displays a preview image based on the obtained image adjustment information on a display of the electronic device without forcing the projection device to display the image.

A displaying system according to yet another embodiment of the present invention includes:

an electronic device including at least one first processor and a display; and

a projection device including at least one second processor,

wherein the at least one first processor of the electronic device:
obtains image adjustment information on adjustment of an image to be projected by the projection device;
instructs the display to display a preview image that is based on the obtained image adjustment information; and
sends image data on the preview image to the projection device, and

wherein the at least one second processor of the projection device:
instructs projection of an image that is based on the image data sent from the electronic device.

### BRIEF DESCRIPTION OF DRAWINGS

FIG. 1 is a block diagram of an image displaying system according to an embodiment of the present invention, illustrating the configuration thereof;

FIG. 2 illustrates an example of gamma conversion information stored in a projector of the image displaying system according to the embodiment of the present invention;

FIG. 3 illustrates an example of light intensity information stored in the projector of the image displaying system according to the embodiment of the present invention;

FIG. 4 is a flowchart of a process when a PC is connected to the projector of the image displaying system according to the embodiment of the present invention;

FIG. 5 is a flowchart of a process when an image is projected by the projector of the image displaying system according to the embodiment of the present invention;

FIG. 6 is a flowchart of a process when a preview of an image to be projected is displayed on the PC of the image displaying system according to the embodiment of the present invention;

FIG. 7 illustrates a first dialog that is displayed on a display of the PC of the image displaying system according to the embodiment of the present invention; and

FIG. 8 illustrates a second dialog that is displayed on a display of the PC of the image displaying system according to the embodiment of the present invention.

### DETAILED DESCRIPTION OF EMBODIMENTS

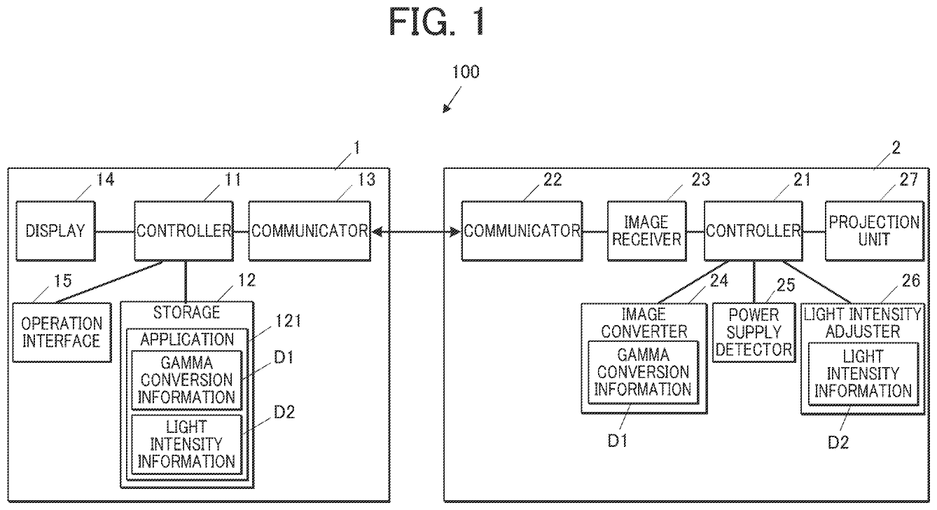

Hereinafter, an image displaying system 100 according to an embodiment of the present invention will be described based on FIG. 1 to FIG. 8. However, the technical scope of the present invention is not limited to the illustrated examples. As used herein, an image may be a static image or a motion image. Further, an object to be displayed is not particularly limited and may be any object that is displayable by a projector 2 such as a picture, a figure and a text.

### 1. Description of Configuration

As illustrated in FIG. 1, the image displaying system 100 includes, for example, a personal computer (PC) 1, and a projector (projector device) 2. The image displaying system 100 is configured such that the PC 1 outputs contents to the projector 2, and the projector 2 projects the contents on a projection medium such as a screen.

The PC 1 and the projector 2 are connected to each other via a wireless LAN, a cable, or the like.

### (1) PC

As illustrated in FIG. 1, the PC 1 includes, for example, a controller 11 (processor), a storage 12, a communicator 13, a display 14, and an operation interface 15.

The controller 11, which controls the operation of the PC 1, includes, for example, a central processing unit (CPU), a read only memory (ROM), a random access memory (RAM), and the like. The controller 11 performs processing by the CPU cooperating with a program and the like stored in the storage 12, which is described later along with processes performed by the system.

The storage 12 is a portion in which various information required for operating the PC 1 is stored. For example, the storage 12 is constituted by a hard disk drive (HDD), a semiconductor memory, or the like. The storage 12 stores data required for operating the PC 1 such as program data in a readable and writable manner for the controller 11.

In the storage 12, an application 121 is stored.

The application 121 is a program including various instructions to the controller 11 for operating the PC 1. The operation of the PC 1, which is described later, is performed according to the application 121.

The communicator 13 is constituted by, for example, a wireless LAN interface, which is used for communication between the PC 1 and the projector 2.

The communicator 13 includes, for example, a communication integral circuit (IC) and the like to perform data communication using a predetermined communication protocol by the control of the controller 11.

The display 14 includes, for example, a display device such as a liquid crystal display (LCD). The display 14 displays an image on a display screen based on a display control signal output from the controller 11.

The operation interface 15 includes, for example, a keyboard that has character entry keys, number entry keys and other keys to which various functions are assigned. The operation interface 15 receives an operation input by a user of the PC 1 and outputs an operation signal corresponding to the operation input to the controller 11. The operation interface 15 may be constituted by a touch panel or the like that is integrally formed with the display 14.

### (2) Projector

As illustrated in FIG. 1, the projector 2 includes, for example, a controller 21 (processor), a communicator 22, an image receiver 23, an image converter 24, a power supply detector 25, a light intensity adjuster 26, and a projection unit 27.

The projector 2 is configured such that the image receiver 23 receives image data from the PC 1 via the communicator 22, the image converter 24 converts the received image data, and thereafter the projection unit 27 projects an image based on the converted image data on a projection medium such as a screen at a light intensity adjusted by the light intensity adjuster 26.

The controller 21 controls the operation of the projector 2. The controller 21 includes, for example, a CPU, a ROM, a RAM, and the like to perform processing described later along with the processes.

The communicator 22 is constituted by, for example, a wireless LAN interface, which is used for communication between the projector 2 and the PC 1.

The communicator 22 includes, for example, a communication integrated circuit (IC) to perform data communication according to a predetermined communication protocol under the control of the controller 21.

The image receiver 23 receives image data from the PC 1 via the communicator 22 by the control of the controller 21.

The image converter 24 has gamma conversion information D1. By the control of the controller 21, the image converter converts image data received by the image receiver 23 according to a user setting for the image quality expression mode.

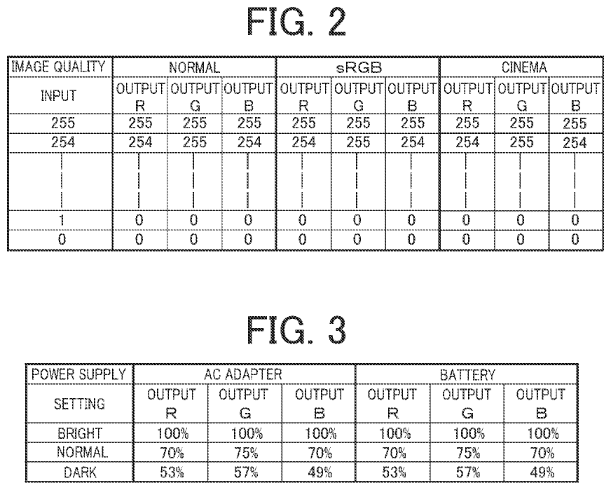

As illustrated in FIG. 2, the gamma conversion information D1 is information on gamma conversion of RGB colors, which is preset for each of image quality expression modes (e.g. standard, sRGB, cinema, etc.).

The power supply detector 25 detects the type of power supply connected to the projector 2 by the control of the controller 21. As a driving power supply, the projector 2 can use an AC adapter that receives external electric power or a battery equipped with the projector 2. The power supply detector 25 can detect which of them is connected.

The light intensity adjuster 26 has light intensity information D2. By the control of the controller 21, the light intensity adjuster 26 individually controls the light intensities of RGB colors projected by the projection unit 27 according to the information on the type of power supply detected by the power supply detector 25 and a user light intensity setting.

As illustrated in FIG. 3, the light intensity information D2 is information on the light intensities (%) of light sources (RGB) that are preset for each type of driving power supply (e.g. AC adapter or battery) and each of light intensity settings (e.g. three levels of “bright”, “normal”, “dark”).

The projection unit 27 includes, for example, a light source, a fluorescent plate, a projection element, a projection lens, and the like. By the control of the controller 21, the projection unit 27 projects an image of the image data converted by the image converter 24 on a screen or the like at the light intensity adjusted by the light intensity adjuster 26.

### 2. Description of Operation

Next, the operation of the image displaying system 100 according to the embodiment will be described.

### (1) Connection of PC and Projector

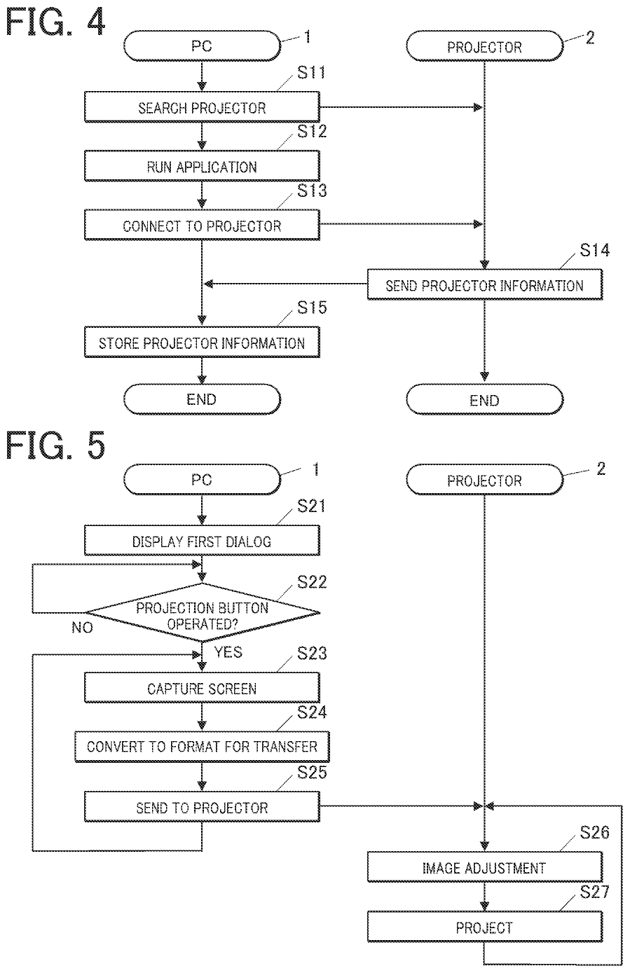

First, a process when the PC 1 is connected to the projector 2 will be described based on the flowchart of FIG. 4.

In response to a predetermined user operation on the operation interface 15, the controller 11 of the PC 1 searches a projector 2 that is connectable to the PC 1 (Step S11). Once the connectable projector 2 is detected, the controller 11 runs an application 121 stored in the storage 12 (Step S12).

Once the application 121 is launched, the controller 11 of the PC 1 displays a predetermined icon representing the detected projector 2 on a screen of the application 121 displayed on the display 14. In response to a predetermined user operation on the operation interface 15 to operate the icon, the connection between the PC 1 and the projector 2 is established (Step S13).

Once the connection between the PC 1 and the projector 2 is established, the controller 21 of the projector 2 sends the gamma conversion information D1 and the light intensity information D2 to the PC 1 via the communicator 22 (Step S14).

By the communicator 13, the PC 1 receives the gamma conversion information D1 and the light intensity information D2 sent from the projector 2. Then, the controller 11 stores the gamma conversion information D1 and the light intensity information D2 in the application 121 in the storage 12 (Step S15).

### (2) Image Projection by Projector

Next, a process when the projector 2 projects an image based on the image data sent from the PC 1 to the projector 2 will be described based on the flowchart of FIG. 5.

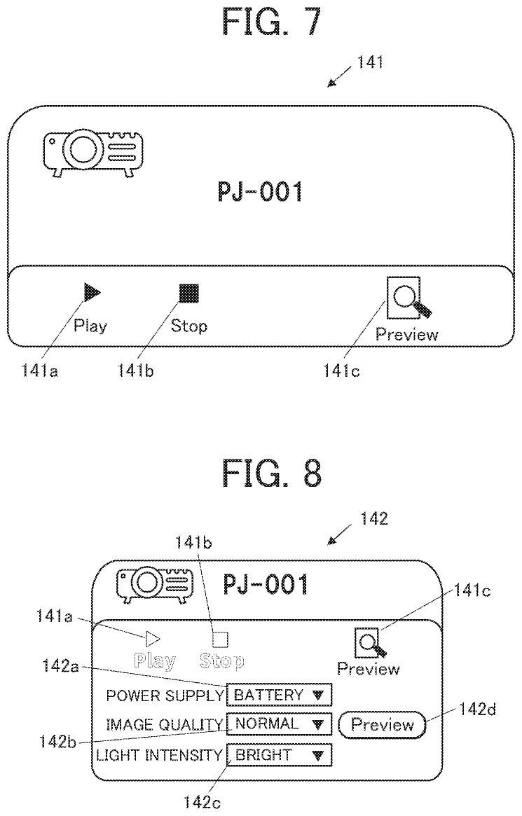

In the PC 1 that has established the connection to the projector 2, the controller 11 displays a first dialog 141 as illustrated in FIG. 7 on the screen of the application 121 displayed on the display 14 (Step S21).

As illustrated in FIG. 7, the first dialog 141 includes a projection button 141a for a user operation to project an image by the projector 2, a projection stop button 141b for a user operation to stop image projection by the projector 2, and a first preview button 141c for a user operation to show a preview of an image to be projected by the projector 2.

In response to detecting a user operation on the operation interface 15 of the PC 1 of operating the projection button 141a (Step S22), the controller 11 captures a screen image being displayed on the display 14 of the PC 1 (Step S23).

Once the screen image is captured, the controller 11 converts the format of image data on the captured screen image to a predetermined format for transfer to the projector 2 (Step S24), and then sends the converted image data to the projector 2 via the communicator 13 (Step S25).

The projector 2 receives the image data sent from the PC 1 by the image receiver 23 via the communicator 22. Then, to the image data, the image converter 24 applies the gamma conversion information D1, specifically preset values corresponding to an image quality expression mode that is preset by the user. Further, the light intensity adjuster 26 applies the light intensity information D2, specifically preset values corresponding to the type of driving power supply connected and a user light intensity setting (Step S26). Then, the projection unit 27 projects an image based on the converted image data (Step S27).

By repeating the routine of Step 23 to Step 27, the projector 2 can project an image that is the same as the image displayed on the display 14 of the PC 1 and that has been subjected to the image adjustment.

### (3) Preview of Projection Image on PC

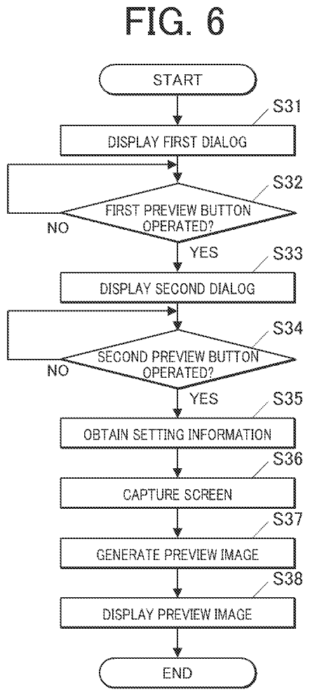

Next, a process when the PC 1 shows a preview of an image to be projected by the projector 2 will be described based on the flowchart of FIG. 6.

As described above, in the PC 1 that has established connection to the projector 2, the controller 11 displays the first dialog 141 as illustrated in FIG. 7 on the screen of the application 121 displayed on the display 14 (Step S31).

In response to detecting a user operation on the operation interface 15 of the PC 1 to operate the first preview button 141c (Step S32), the controller 11 displays a second dialog 142 as illustrated in FIG. 8 on the screen of the application 121 displayed on the display 14 (Step S33).

In addition to the same buttons of the first dialog 141, which are the projection button 141a, the projection stop button 141b and the first preview button 141c, the second dialog 142 further includes a power supply selector 142a allowing the user to select the type of driving power supply connected to the projector 2 (e.g. AC adapter or battery), an image quality selector 142b allowing the user to select an image quality expression mode to be applied for projection by the projector 2 (e.g. standard, sRGB, cinema, or the like), a light intensity selector 142c allowing the user to select a light intensity setting to be applied for projection by the projector 2 (e.g. one of three levels of “bright”, “normal” or “dark”), and a second preview button 142d for a user operation to show a preview of an image to be projected by the projector 2, which the user operates after selecting items in the power supply selector 142a, the image quality selector 142b and the light intensity selector 142c.

Once the second dialog 142 is displayed on the display 14, the user selects desired settings for projection by the projector 2, specifically the power supply, the image quality and the light intensity, by operating the power supply selector 142a, the image quality selector 142b and the light intensity selector 142c of the second dialog 142 with the operation interface 15, and then operates the second preview button 142d (Step S34).

In response to detecting the user operation on the second preview button 142d, the controller 11 of the PC 1 obtains the setting information on the power supply, the image quality and the light intensity, which corresponds to the selections on the power supply selector 142a, the image quality selector 142b and the light intensity selector 142c of the second dialog 142 (Step S35).

Subsequently, the controller 11 captures a screen image being displayed on the display 14 of the PC 1 (Step S36), and applies the gamma conversion information D1 and the light intensity information D2, which have been obtained in Step S14 and stored in the storage 12 in Step S15, to the image data on the captured screen image according to the setting information obtained in Step S35, so as to generate image data on a preview image (Step S37).

Specifically, the controller 11 extracts values corresponding to the setting information obtained in Step S35 from the gamma conversion information D1 and the light intensity information D2. Then, the controller 11 multiplies each pixel data of the screen image by the extracted values as coefficients so as to generate the image data that has the same image quality as an image that is to be actually projected by the projector 2.

Once the image data on the preview image is generated, the controller 11 displays the preview image on the display 14 (Step S38).

### 3. Description of Advantageous Effects

Next, some of the advantageous effects of the image displaying system 100 of the embodiment will be described.

In the image displaying system 100 of the embodiment, the PC 1 obtains the information on the image adjustment that is performed for displaying an image by the projector 2. Then, the controller 11 of the PC 1 applies the obtained information on the image adjustment to image data that is generated by capturing a screen image being displayed on the display 14, so as to generate image data on a preview image. Then, the controller 11 displays the preview image on the display 14. This allows the user of the PC 1 to check the image quality of a projection image before the image is actually projected by the projector 2.

When the user finds a portion where the contents would be less visible if projected, the user can correct it. As a result, it is possible to project an image with high visibility from the start of projection.

When the information on the image adjustment to be performed by the projector 2, which is obtained by the PC 1, includes the gamma conversion information D1, the user of the PC 1 can check the result of the gamma conversion to be performed by the projector 2 beforehand.

When the information on the image adjustment to be performed by the projector 2, which is obtained by the PC 1, includes the light intensity information D2, the user of the PC 1 can check the result of the light intensity adjustment to be performed by the projector 2 beforehand.

In a case of the light intensity information D2 obtained by the PC 1 is the type of driving power supply connected to the projector 2 (AC adapter or battery), the user of PC 1 can check the result of the light intensity adjustment to be performed according to the type of driving power supply connected to the projector 2 beforehand.

In PC 1, the controller 11 stores the obtained gamma conversion information D1 and light intensity information D2 in the application 121 in the storage 12. After the PC 1 was once connected to the projector 2, this allows the user to check the image quality of a projection image to be projected by the projector 2 on the PC 1 without the need to connect the PCl to the projector 2.

### 4. Variations

Next, some variations of the embodiment will be described. In the above-described embodiment, the PC 1 obtains the gamma conversion information D1 and the light intensity information D2 from the projector 2, and only the obtained data is reflected in the preview image. However, data that can be reflected in the preview image is not limited thereto.

For example, the light source of RGB colors in the projection unit 27 of the projector 2 gradually deteriorates as the used hours increases, and the light intensity thereof attenuates accordingly. To cope with the problem, the projector 2 may be configured to store the used hours of the light source of the projection unit 27 and create data relating to attenuation in light intensity of the light source based on the used hours. The projector 2 may send the created data to the PC 1, and the PC 1 may receive the data via the communicator 13. Then, the controller 11 of the PC 1 may apply the received data to the image data on the captured screen image to reflect the attenuation in light intensity due to deterioration of the light source, so as to generate the image data on the preview image.

This allows the user to check the attenuation in light intensity due to deterioration of the light source before actual projection by the projector 2.

The degree of deterioration of the light source also depends on the installation environment of the projector 2. For example, dust or dirt may penetrate into the projector 2 and adhere to an optical component. The system may be configured such that the user can select the installation environment of the projector 2 beforehand, for example, from among items such as office, laboratory, factory and outdoor, and the controller 11 creates the data on the light intensity attenuation due to deterioration of the light source based on the selected installation environment in addition to the used hours.

The PC 1 may be configured such that after the preview image is displayed, the user can change the settings for the gamma, the light intensity and the like on the screen of the application 121 displayed on the display 14 of the PC 1 through the operation interface 15. In response to the user changing the settings, the controller 11 sends data on the change to the projector 2 via the communicator 13. Then, the projector 2 may perform the image conversion by the image converter 24 and the light intensity adjustment by the light intensity adjuster 26 according to the change, and then perform projection by the projection unit 27.

This allows the user to adjust a projection image to be actually projected by the projector 2 beforehand.

The controller 11 (processor) of the above-described embodiment displays the preview image based on the image adjustment information obtained by the communicator 13 (transmitter) on the display 14 without displaying it by the projector 2 (projection device). Thereafter, when the user determines that it is not necessary to change the settings for the gamma, the light intensity and the like, the controller 11 may send an instruction to perform projection to the projector 2 via the communicator 13 in response to a predetermined user operation on the operation interface 15, so that the projector 2 (projection device) displays an image that has been subjected to the same image adjustment as that for the preview image. This allows the user to check an image to be displayed before the image is actually displayed by the projector 2 (projection device).

The above-described embodiment illustrates an example system that includes the projector 2 (projection device) that projects an image based on image data, and the PC1 as an electronic device that shows a preview of an image to be displayed by the projector 2. However, the devices that serve as the projector or the electronic device are not limited thereto.

It should be understood that suitable changes can be made to the detailed configuration and operation of each device of the image displaying system 100 of the above-described embodiment without departing from the features of the present invention.

While an embodiment of the present invention is described, the scope of the present invention is not limited to the above-described embodiment but encompasses the scope of the invention defined by the claims and the equivalents thereof.

What is claimed is:

1. A displaying method executed by an electronic device, comprising:
obtaining image adjustment information on image adjustment for a projection device that projects an image based on image data; and
displaying a preview image based on the obtained image adjustment information on a display of the electronic device without forcing the projection device to display the image.

2. The displaying method according to claim 1,
wherein the preview image is based on the image data to which the image adjustment information has been applied.

3. The displaying method according to claim 1, further comprising:
after displaying the preview image on the display, in response to a user operation on the electronic device indicating that any change in setting is necessary for the preview image, forcing the projection device to display a same image as the preview image.

4. The displaying method according to claim 1,
wherein the image adjustment information includes gamma conversion information on gamma conversion that is performed by the projection device.

5. The displaying method according to claim 1,
wherein the image adjustment information includes light intensity information on light intensity adjustment that is performed by the projection device.

6. The displaying method according to claim 5,
wherein the light intensity information of the image adjustment information includes setting values that are different for different types of driving power supplies connected to the projection device.

7. The displaying method according to claim 6,
wherein the types of driving power supplies includes a power supply via an AC adapter and a power supply from a battery.

8. The displaying method according to claim 5,
wherein the light intensity information of the image adjustment information includes setting values that are different for different light intensity settings of the projection device.

9. The displaying method according to claim 8,
wherein the light intensity settings includes bright, normal and dark.

10. The displaying method according to claim 1, further comprising:
storing the image adjustment information in a storage of the electronic device.

11. The displaying method according to claim 1, further comprising:
obtaining light source information from the projection device, the light source information indicating a degree of deterioration of a light source of a projection unit of the projection device; and
displaying the preview image that is based on the image adjustment information and the light source information on the display without forcing the projection device to display the preview image.

12. The displaying method according to claim 11,
wherein the information on the degree of deterioration of the light source of the projection unit is generated based on an installation environment of the projection device.

13. The displaying method according to claim 1, further comprising:
obtaining setting change information on a change of setting for the preview image by a user of the electronic device; and
sending the setting change information to the projection device via a communicator of the electronic device.

14. An electronic device, comprising:
at least one processor that executes a program stored in a storage,
wherein the at least one processor:
obtains image adjustment information on image adjustment for a projection device that displays an image based on image data; and
displays a preview image based on the obtained image adjustment information on a display of the electronic device without forcing the projection device to display the image.

15. The electronic device according to claim 14,
wherein the preview image is based on the image data to which the image adjustment information has been applied.

16. A displaying system, comprising:
an electronic device including at least one first processor and a display; and
a projection device including at least one second processor,
wherein the at least one first processor of the electronic device:
obtains image adjustment information on adjustment of an image to be projected by the projection device;
instructs the display to display a preview image that is based on the obtained image adjustment information; and
sends image data on the preview image to the projection device, and
wherein the at least one second processor of the projection device:
instructs projection of an image that is based on the image data sent from the electronic device.

17. The displaying system according to claim 16,
wherein the preview image is based on the image data to which the image adjustment information has been applied.

18. The displaying system according to claim 16,
wherein the at least one first processor of the electronic device:
after instructing the display to display the preview image, in response to a user operation on the electronic device indicating that any change in setting is necessary for the preview image, sends to the projection device an instruction to project a same image as the preview image, and
wherein the at least one second processor of the projection device:
in response to receiving the instruction, projects the same image as the preview image.

19. The displaying system according to claim 16,
wherein the image adjustment information includes gamma conversion information on gamma conversion that is performed by the projection device.

20. The displaying system according to claim 16,
wherein the image adjustment information includes light intensity information on light intensity adjustment that is performed by the projection device.
